(19) United States
(12) Patent Application Publication
(10) Pub. No.: US 2015/0077653 A1
(43) Pub. Date: Mar. 19, 2015

(54) OPERATING DEVICE AND ELECTRIC APPLIANCE WITH SUCH AN OPERATING DEVICE

(71) Applicant: E.G.O. Elektro-Geraetebau GmbH, Oberderdingen (DE)

(72) Inventor: Jose Antonio Manan, Montcada i Reixac (ES)

(21) Appl. No.: 14/487,775

(22) Filed: Sep. 16, 2014

(30) Foreign Application Priority Data
Sep. 16, 2013 (EP) 13184599.2

(51) Int. Cl. G02F 1/1335; G02F 1/13

(52) U.S. Cl. CPC G02F 1/1336; G02F 1/1313
USPC 349/12; 349/61

(57) ABSTRACT

An operating device for an electric appliance has a display panel for a user to read off information and to operate the electric appliance with operating elements, wherein the display panel has an LCD display covering substantially the area of the display panel. The LCD display has several separate active areas, wherein behind the LCD display a transparent flat material or foil is provided as a picture carrier having several separate pictures on one of its surfaces. Behind the transparent picture carrier a backlight device is provided for lighting through the picture carrier and the LCD display.

### CROSS-REFERENCE TO RELATED APPLICATIONS

This application claims priority to European Application No. 13184599.2, filed Sep. 16, 2013, the contents of which are hereby incorporated herein in its entirety by reference.

### TECHNOLOGICAL FIELD

The invention relates to an operating device for an electric appliance as well as to an electric appliance with such an operating device.

### BACKGROUND

An operating device for a coffee machine as an electric appliance is known for example from EP 2111779 A1, which comprises a display panel and touch switches.

### BRIEF SUMMARY

The object of the invention is to provide an aforementioned operating device for an electric appliance as well such an electric appliance, with which drawbacks of the prior art can be avoided and with which it is in particular possible to provide a simple and energy efficient way to display information to a user, preferably with detailed and colored icons, and to provide a way of operating the appliance.

This object is achieved by the invention with an operating device as well as an electric appliance. Advantageous and preferred embodiments of the invention are the subject of the further claims and will be explained in more detail in the following. Some of the technical features will be described only for the operating device or only for the electric appliance. However, independently thereof, they shall be applicable to the operating device as well as to the electric appliance in independent manner. The wording of the claims is incorporated into the description by explicit reference.

The operating device has a display or a display panel, respectively, for a user where information or icons can be displayed and the user can see them or read them off.

Furthermore or alternatively, the user may operate the electric appliance with operating elements provided on the display panel or on the operating device, respectively. The display panel has an LCD display covering substantially the area of the display panel, wherein preferably the LCD display makes up a major part of the display panel. The LCD display has several separate active areas, which means that they can be activated or deactivated in the manner of a conventional LCD. Preferably these areas are in a simple basic geometrical shape, for example in rectangular or square shape. These separate active areas can preferably make up most part of the LCD display.

According to the invention, behind the LCD display a transparent flat material, preferably in the form of a transparent foil, is provided and has several pictures, icons or symbols on one of its surfaces. This transparent flat material or foil forms a picture carrier for the display panel. The pictures, icons or symbols are preferably applied to only one of its surfaces, in particular to the top surface. Behind the transparent picture carrier a backlight device is provided for shining or lighting through the picture carrier and through the LCD display. This backlight device is preferably a conventional backlight device that can regularly be used for LCD displays as they do not have any own light source.

In this way, it is possible to make the display panel and especially the LCD display in a way that by activating or deactivating the several active areas the LCD display is either transparent or black and non-transparent. In the transparent state, the pictures, icons or symbols provided on the picture carrier being lit from behind by the backlight device are visible in backlighted manner, which provides for a very clear, bright and detailed view. Preferably the separate active areas of the LCD display correspond in size to the pictures, icons or symbols, for example in a way that each picture, icon or symbol has its own separate active area and can be covered by the area or be revealed.

Thus, the invention provides for an operating device with a display panel with which very detailed and high resolution pictures, icons or symbols can be used, even in any bright colour. However, there is no need to provide for an expensive and energy consuming active display such as TFT or LED-displays. High resolution pictures can be displayed with only minor effort. Furthermore, an LCD display is much less energy consuming than TFT or even LED-displays.

In preferable manner the active areas of the LCD display are arranged according to a pattern. The pattern may be provided as a pattern field with several pattern areas. The pattern areas may be of any arbitrary size or form defining the active areas. However, for an easier division of the active areas as well as of the pictures, icons or symbols on the picture carrier, they can have an average size of a regular pattern. Some of the active areas may correspond to one such pattern area. Other active areas may correspond to the size and form of a number of such pattern areas, for example two to five such pattern areas.

In even more preferable manner, the LCD display is a common LCD display with a resolution of at least fifty or a hundred pixels horizontally and vertically, for example with a resolution of 50×50 pixels or higher, possibly even a VGA or SVGA resolution. This provides for the option to display other information or symbols than just the ones with the pictures from the flat material or foil, for example indications of power or time for a timer function. This corresponds to the conventional function of an LCD display, whereas the function with covering or uncovering the pictures from the flat material or foil is rather a shutter function. Even in the place where the above-mentioned active areas are to be provided the LCD display has dozens of separate pixels for one such active area. They are however combined to function as one area being activated or deactivated together. The use of standard LCD displays provides is more cost-efficient and their control can be made with standard software and hardware solutions.

In a further embodiment of the invention, the backlight device provides for a uniform and homogeneous lighting effect across its surface. This corresponds to conventional backlight devices as known to a person skilled in the art in the field of backlit LCD devices. However, as obviously a major part of the pictures, icons or symbols shall not be displayed or, respectively, only a minor part of the area of the display panel shall be used at the same time and lit from behind for this use, also the backlight device can be divided into several fields corresponding to the active areas of the LCD display or, even better, corresponding to each picture, icon or symbol of the picture carrier. In this way, only the picture, icon or symbol that is to be displayed is lit from behind, which may again safe energy. The covering of the remaining area of the picture carrier by the black and non-transparent LCD display is advantageous nonetheless, because usually such a backlight device has a light diffusing means on its surface which provides for a uniformly distributed lighting effect and does not allow for a strictly defined light field.

In an advantageous embodiment of the invention, the backlight device is provided with LED as a light source and light diffusing means above the LED. Preferably, a standard backlight device for LCD displays can be used.

It is basically possible to use as an LCD display a so-called positive LCD, which means that it is transparent in an inactive state without excitation voltage. In this way, a picture, icon or symbol from the picture carrier being backlit from behind is visible for a user. Only in the active areas connected to an excitation voltage, the LCD display is active, which means that its active areas are black and the pictures, icons or symbols underneath it are covered and not visible.

In a preferred embodiment of the invention, the LCD display is a negative LCD, which means that its active areas or the LCD has a whole, respectively, are black and intransparent in an inactive state without excitation voltage. This results in the picture carrier being covered and being invisible in an inactive state of the LCD display, which obviously is very energy efficient. Only when some of the active areas are activated by an excitation voltage do they become transparent so that the pictures, icons or symbols underneath it become visible, which is improved much by the backlight device. In consequence, only energy for making those active areas transparent is needed that shall reveal the pictures, icons or symbols underneath to be visible. Furthermore, if the backlight device can be partly activated, for example corresponding to the above mentioned pattern or the pictures, icons or symbols of the picture carrier, together with an activation of an active area of the LCD display, this part of the backlight device can be switched on. This allows for a further reduction in energy consumption even in the display state.

In a further embodiment of the invention, the picture carrier can cover only a part of the LCD display, which may be a major part of it, for example 60% or 80%. The rest of the LCD display is provided with conventional LCD symbols being backlit by the backlight device. This allows for a more flexible display of information which cannot be provided for by pictures, icons or symbols in a fixed manner. For example different power levels or a timer setting may advantageously be displayed by such LCD symbols, possibly in the form of so-called seven-segment displays. This can be realized with a positive LCD as well as with a negative LCD as mentioned before.

In an even further embodiment of the invention, capacitive sensor elements for touch switches as operating elements of the operating device may be provided on the display panel. Such is basically known, for example from the above mentioned EP 2111779 A1. Such capacitive sensor elements are preferably made from a transparent and electrically conductive material, for example ITO. They can be printed or affixed, respectively, to the LCD display. This can be done directly onto the LCD display, for example on the upper side of it or on its upper protective glass sheet, respectively. Furthermore, it is possible to provide a further protective cover above the LCD display, for example made from glass or acrylic resin and which may also be a part of the electric appliance. In this case, the capacitive sensor elements for the touch switches can also be provided on the underside of such a protective cover. They can be directly printed on the underside or otherwise be applied to it from the above mentioned electrically conductive and transparent material. Alternatively, the capacitive sensor elements may be provided on a foil carrier or the like, which is then applied to the underside of the cover, alternatively on the upper side of the LCD, for example with an adhesive. Such a foil carrier can preferably also be provided with contact pads and contact tracks to the sensor elements, preferably made from the same material, which allows for an electrical connection to a control, preferably the control of the operating device.

Capacitive sensor elements or touch sensors could be in the size of one of the active areas or pictures from the flat material or foil. Preferably they are provided according to a matrix in substantially equal size and distribution. That provides for the possibility to have them everywhere over the LCD display and in many possible configurations. This also provides for the option to employ conventional and often-used matrix touch switches, which is more cost-efficient, and their control can be made with standard software and hardware solutions.

The electric appliance in which such an operating device may be incorporated can basically be any electric appliance. The operating device according to the invention is then preferably arranged in a manner corresponding to conventional operating devices.

In preferred manner, the electric appliance is of a kind that can have a display panel with several different options being suitable for display by pictures, icons or symbols. Preferred examples for such an electric appliance are a vending machine or a coffee machine, alternatively a cooking appliance such as an oven, a steamer or a cook top operated by electricity or gas. Further preferable examples are washing machines, dishwashers and refrigerators.

These features and further features arise not only from the claims but from the description and the drawings, wherein the individual features can be realized in each case on their own or in sub-combinations thereof in an embodiment of the invention and in other fields and can represent advantageous embodiments protectable per se, for which protection is hereby claimed. The division of the application into individual sections as well as cross headings does not limit the general validity of the statements made therein.

### BRIEF DESCRIPTION OF THE SEVERAL VIEWS OF THE DRAWINGS

Exemplary embodiments of the invention are schematically shown in the drawings and will be explained in more detail in the following. The drawings show in:

FIG. 1 is an exploded view on the components of an operating device according to the invention with an LCD display, a picture carrier and a backlight device,

FIG. 2 is the operating device of FIG. 1 in more packed manner,

FIG. 3 is a sectional view of the operating device of FIG. 2 underneath a cover of an electric appliance and

FIG. 4 is a coffee machine as an electric appliance according to the invention with a display panel with the operating device of the invention.

### DETAILED DESCRIPTION

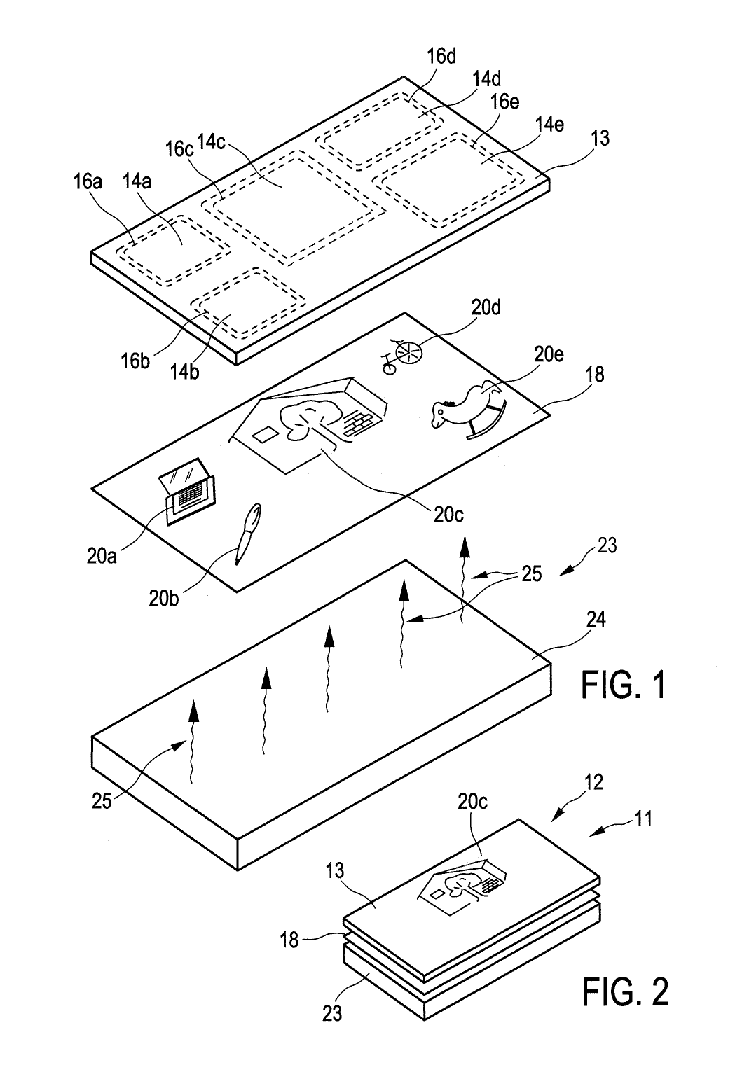

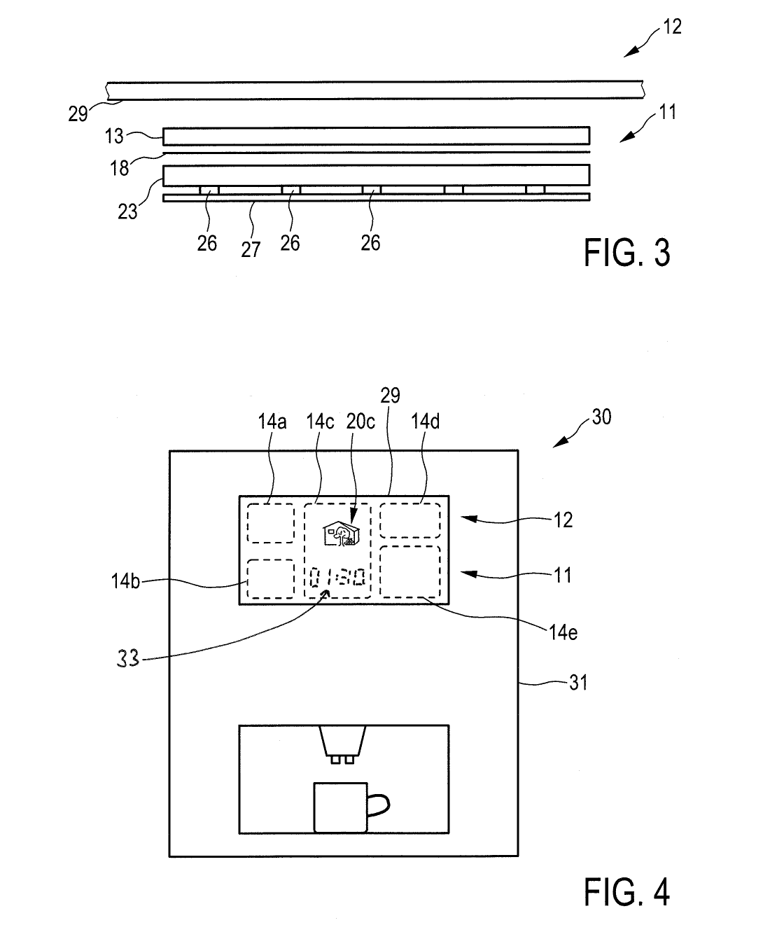

FIG. 1 shows an operating device 11 in an exploded view forming a display panel 12 according to FIG. 3. An LCD display 13, in this case a so-called negative LCD, is provided in flat and rectangular form. The LCD display could also be curved or partly spherical. Furthermore, the LCD display 13 has several active areas 14a to 14e, which are provided in a distributed manner. The active areas 14a and 14b on the left are substantially square-like and have the same size. The middle active area 14c is a large one, and on the right side two differently shaped rectangular active areas 14d and 14e are provided. As the LCD display 13 is a negative LCD, it is black in a deactivated state or without an excitation voltage applied to it, respectively. The active areas 14a to 14e can be turned transparent by applying an excitation voltage to it, which renders the LCD display 13 transparent in this area.

On the top side of the LCD display 13, capacitive sensor elements 16a to 16e are provided, which are shown in broken lines. They are made up of a transparent material such as ITO and are connected to an electronic control, which preferably also controls the LCD display 13. The capacitive sensor elements 16a to 16e correspond in shape and location largely to the active areas 14a to 14e. They form touch switches as operating elements in the operating device 11 or an electric appliance equipped with the operating device, as is for example known from the prior art of EP 2111779 A1.

Underneath the LCD display 13 a picture carrier 18 is provided. The picture carrier 18 is basically made up from a thin transparent material, preferably as a foil, the material being rather thin and somewhat flexible. On the basically transparent picture carrier 18, several pictures 20a to 20e are provided, for example printed to it in known manner. Their location corresponds to the one of the active areas 14a to 14e and their size or extension is somewhat smaller. This provides for a good covering of the pictures 20a to 20e by the active areas 14a to 14e as non-transparent cover in their deactivated state.

Underneath the picture carrier 18, a backlight device 23 is provided. This is preferably a conventional backlight device with light diffusing material 24 on its top side or forming its upper side. Light 25 being emitted from the backlight device 23 is largely uniformly distributed and provides a homogenous shine. This light 25 also provides for a characteristic and easily visible backlighting of the pictures 20a to 20e when the respective active area 14a to 14e above is activated and turned transparent. The light 25 can be regular white light, alternatively be colored light.

From FIG. 2 it can be taken that the operating device 11 basically has the size of a conventional operating device with a backlit LCD display. In the state shown in FIG. 2, the middle picture 20c is visible and also lit from behind. This means that the corresponding active area 14c has been activated and turned transparent. The other active areas are still deactivated and black, which covers and darkens the other pictures.

FIG. 3 shows the operating device 11 being mounted underneath or behind a cover 29, thus forming a display panel 12. Cover 29 is also transparent and can be glass or suitable resin. In the side view, it can be seen that the backlight device 23 is provided with several LED 26 underneath it, placed upon a printed cardboard 27. In another embodiment of the backlight device 23, the light sources or the LED 26, respectively, can be integrated into the backlight device 23.

FIG. 4 shows a coffee machine 30 as an electric appliance according to the invention. The coffee machine 30 has a housing 31 in conventional manner. On the upper part of the front side an operating device 11 as display panel 12 is provided behind a transparent cover 29, which is integrated into the housing 31 or forms a part of it. With the capacitive sensor elements integrated as touch switches, it is possible to operate the coffee machine 30 by touching one of the lit pictures or symbols of the operating device 11 with a finger, for example picture 20c, and thus activate the corresponding operating function.

Beneath the picture 20c an additional indication 33 of time for a timer function is provided with “01:30”. Although this indication 33 rather seems to be in the form of a simple seven digit display, it can be displayed with the higher resolution of the LCD display 13 and in more or other detailed form.

That which is claimed:

1. An operating device for an electric appliance, wherein said operating device comprises:
operating elements and a display panel for a user to read off information or to operate said electric appliance with said operating elements,
wherein said display panel comprises an LCD display covering substantially a whole area of said display panel and,
wherein said LCD display comprises several separate active areas, wherein behind said LCD display a transparent flat material or foil is provided with a front surface and a back surface as a picture carrier having several separate pictures, icons or symbols on one of said surfaces, wherein behind said transparent picture carrier a backlight device is provided for shining through said picture carrier and said LCD display.

2. The operating device according to claim 1, wherein said active areas of said LCD display are arranged according to a pattern with an average size of pattern areas of a pattern field.

3. The operating device according to claim 2, wherein some said active areas are made up of two to five said pattern areas.

4. The operating device according to claim 1, wherein said backlight device provides for a uniform and homogenous lighting effect across its surface area.

5. The operating device according to claim 4, wherein said backlight device is provided with LED and light diffusing means above said LED.

6. The operating device according to claim 1, wherein said LCD display is a negative LCD and said active areas are in an idle state black without excitation voltage, and are in a display state transparent with an excitation voltage applied to said active areas.

7. The operating device according to claim 1, wherein said picture carrier covers only a part of said LCD display, wherein a rest of said LCD display is provided with conventional LCD symbols being backlighted by said backlight device.

8. The operating device according to claim 7, wherein said picture carrier covers a major part of said LCD display.

9. The operating device according to claim 7, wherein said picture carrier covers a major part of said LCD display.

10. The operating device according to claim 9, wherein said picture carrier covers said whole LCD display.

11. The operating device according to claim 1, wherein transparent capacitive sensor elements for touch switches as said operating elements are provided on said display panel.

12. The operating device according to claim 11, wherein said transparent capacitive sensor elements are made from ITO.

13. The operating device according to claim 11, wherein said transparent capacitive sensor elements are provided on said LCD display.

14. The operating device according to claim 11, wherein said transparent capacitive sensor elements are provided on an upper side of said LCD display.

15. An electric appliance, wherein it is provided with an operating device according to claim 1.

16. The electric appliance according to claim 15, wherein said electric appliance is a vending machine or a coffee machine.
